(19) United States
(12) Patent Application Publication
(10) Pub. No.: US 2009/0079390 A1
(43) Pub. Date: Mar. 26, 2009

(54) RECHARGEABLE BATTERY ARRAY

(76) Inventors: Kai-Wai Alexander Choi, Houston, TX (US); Sheung Wa Chan, Hong Kong (HK)

Correspondence Address: TROUTMAN SANDERS LLP;RYAN A. SCHNEIDER, ESQUIRE, 600 PEACHTREE STREET , NE, 5200 BOA PLAZA, ATLANTA, GA, 30308, US

(21) Appl. No.: 11/861,872

(22) Filed: Sep. 26, 2007

(51) Int. Cl. H02J 7/00

(52) U.S. Cl. 320/122

(57) ABSTRACT

Rechargeable battery array is described. The rechargeable battery array is constructed from: a battery row 101 that includes a plurality of battery cells 102, 103 connected in parallel for supplying a larger current; and at least one balancing circuit 105 in the battery row, the balancing circuit provides a high impedance path across that battery row initially when charging process begins, and provides a path of desired constant voltage drop across that battery row when voltage across that battery row rises close to the charge termination voltage. The rechargeable battery array may further include a plurality of the battery rows 101, 111, 121 connected in series for supplying a higher voltage; and at least one balancing circuit 105 for each of the battery rows 101, 111, 121. The rechargeable battery array may also have at least one balancing circuit on each battery cell that is responsive to the voltage across that battery cell. The rechargeable battery array can be efficiently charged despite of capacity mismatch and/or failure in certain battery cells in the array.

### TECHNICAL FIELD

The present invention relates generally to rechargeable batteries and, in particular, to methods and apparatus for charging serially connected rechargeable batteries.

### BACKGROUND OF INVENTION

Rechargeable battery has been widely used as power source for low power consumption electronic devices such as digital camera, laptop computers, and mobile phones. The electrical voltage and current delivered by a rechargeable battery is limited by the battery chemistry. Recent development in battery technology has overcome challenges such as high energy density and long cycle time, making heavy duty applications possible. Rechargeable battery is now available for Battery Electric Vehicles (BEV), hybrid vehicles, and load leveling machines.

Rechargeable battery can increase the output power by configuring its voltaic cells in parallel, series, or in both to form an array structure. A parallel configuration of cells can supply a higher current whereas a series configuration offers the sum of the voltages of all the cells in series. To charge such battery array, a charging current is usually applied across the positive and negative terminals of the battery array. Series cell configuration however suffers from a problem that, if one cell charges up faster than its neighbor, the full cell will limit the charging current flowing into the non-full cells. As a result, some of the cells in the battery take a long time to charge up and the charging process is inefficient. Most often, the user cannot wait until all cells are charged up or fully charged. The charging process has to be terminated with some of the cells not fully charged. The overall energy storing capacity of the battery cannot be fully utilized. As the battery cells degrade over use, charging capacity among cells becomes more deviated. The problem of unbalanced charging also gets more serious, and undesirably wastes a significant portion of the battery capacity. Apart from unbalanced charging, intrinsic faults in cells may also limit the charging current to neighbor cells.

Even if the user can tolerate a long charging time and the limited charging current may at long last charge up other cells, another problem is caused by the continuous application of charging current to those fully charged cells. As a result, the cell life may be substantially shortened.

A conventional method for solving the problem of unbalanced charging in serially connected battery cells is by battery cell matching during the manufacturing process. In this method, the charging capacity of each battery cell is measured after production. According to the measurement results, the batteries are categorized into various grades. Battery cells of the same grade are used in the same battery array to improve initial balance of charging capacity. Such steps result in extra manufacturing costs and time. Furthermore, the step of cell matching only improves unbalanced charging by trying to minimize the difference of charging capacity between cells, however difference in charging capacity still exists and the problem is not ultimately solved. In addition, significant capacity mismatch still happens in spite of initial cell matching when the battery cells start to degrade after prolonged use.

A need exists for a rechargeable battery array that can be efficiently charged despite of capacity mismatch and/or failure in a certain battery cell in the array.

### SUMMARY

It is a primary object of this invention to overcome the shortcoming of known existing rechargeable battery array and provide an improved rechargeable battery array that can be efficiently charged despite capacity mismatch and/or failure in certain cells among the battery array.

Accordingly, aspects of the present invention have been developed with a view to substantially eliminate the drawbacks described hereinbefore and to provide low complexity architecture of a rechargeable battery array and a low-complexity method for charging a rechargeable battery array.

The claimed invention relates to a rechargeable battery array that includes a number of serially connected battery rows, each battery row can be a single battery cell or can be constructed by connecting a number of battery cells in parallel configuration. At least one balancing circuit is arranged in parallel with each battery row and provides a path of desired constant voltage drop when all the cells in that battery row are substantially charged up.

The balancing circuit provides a high impedance path across that battery row initially when charging process begins. As charging continues, the balancing circuit keeps monitoring the voltage across that battery row. When voltage across that battery row rises close to the charge termination voltage (e.g.: 3.65V), which is the expected voltage delivered by a substantially charged up battery cell, the balancing circuit provides a path of desired constant voltage drop across that battery row.

In previous battery arrays without balancing circuit, some battery rows may charge up faster than others. As the voltage across a battery row rises close to the charge termination voltage, the battery row starts to limit the charging current passing through itself to a small magnitude. Since this substantially charged up battery row is serially connected to other battery rows, the current that charges up these other battery rows drops significantly. Consequently, it takes an unreasonably long time to charge up all battery rows in the battery array. The situation gets worse when the variation of battery cell capacity increases, for example, due to battery degradation, production defects, or manufacturing process variation. It may happen that the capacity of one battery row is much smaller than the others. This problematic battery row gets charged up quickly and limits the charging current while the other rows still have a long way ahead to become fully charged.

To overcome the problems of charging current limitation to non-fully charged cells, the claimed and related battery array of the invention addresses these and other problems through a novel architecture and related method of battery charging to avoid undesired charging current limitation as a battery row gets substantially charged up.

The battery array for the presently claimed invention employs a balancing circuit that provides a bypass path of desired constant voltage drop when that battery row become substantially charged up. The constant voltage drop is maintained by analog feedback circuit and is desired to be the same as the expected charge termination voltage. This bypass path of constant voltage drop on one hand exhibits very low impedance against the charging current. As such, other non-fully charged battery rows can still be charged by a sufficiently large current such that the whole battery array can be fully charged in a much shorter time. On the other hand, the bypass path of constant voltage drop functions as a constant voltage source to continue charging the substantially charged up battery row until it is fully charged.

Furthermore, when the stored charge in that battery row starts to drop due to current leakage, the constant voltage source can help to maintain the charge level.

Since a large current may pass through the bypass path when the balancing circuit is providing a constant voltage drop, considerable heat may be generated in the balancing circuit. Heat dissipation can be facilitated by integrating the balancing circuit with the package of the battery cell. The balancing circuit may be packaged such that it is in thermal contact with the battery case, usually made of metal and is highly thermal conductive. As such, there is provided an efficient thermal dissipation path for the heat generated in the balancing circuit.

The rechargeable battery array may also include a thermo-protecting circuit that automatically breaks the bypass path of constant voltage drop at high temperature.

For better power management, the rechargeable battery array for the presently claimed invention may additionally includes an under voltage detection circuit. The under voltage detection circuit can disable a substantial portion of the balancing circuit, especially the current consuming analog devices, when the voltage across each battery row gets lower than the operating voltage.

Through the foregoing arrangement, improved battery array architectures that can be efficiently charged despite of capacity mismatch and/or failure in a certain cells among the battery array are realized.

Other aspects of the invention are also disclosed.

### BRIEF DESCRIPTION OF DRAWINGS

Embodiments of the invention are described in more detail hereinafter with reference to the drawings, in which:

FIG. 1a is a block diagram illustrating a rechargeable battery array in conventional art;

FIG. 1b is a block diagram illustrating a rechargeable battery array in accordance with an embodiment of the invention;

FIG. 1c is a block diagram illustrating a rechargeable battery array in accordance with yet another embodiment of the invention;

FIG. 2 is circuit schematics of a balancing circuit in accordance with an embodiment of the invention;

FIG. 3a is a plot of voltage across a rechargeable battery array undergoing charging process in conventional art;

FIG. 3b is a plot of charging current for a rechargeable battery array undergoing charging process in conventional art;

FIG. 3c is a plot of voltage across a rechargeable battery array undergoing charging process in accordance with an embodiment of the invention;

FIG. 3d is a plot of charging current for a rechargeable battery array undergoing charging process in accordance with an embodiment of the invention;

FIG. 4 is a flow diagram for the charging of a rechargeable battery array in accordance with an embodiment of the invention;

FIG. 5 is circuit schematics of a balancing circuit in accordance with a further embodiment of the invention;

FIG. 6 is a plot of voltage across a rechargeable battery cell undergoing discharging process in accordance with an embodiment of the invention;

FIG. 7 is a flow diagram for the discharging of a rechargeable battery cell in accordance with an embodiment of the invention;

FIG. 8 is a perspective view of a battery array in accordance with one or more embodiments of the invention;

FIG. 9 is the schematics of a battery package in accordance with an embodiment of the invention;

FIG. 10a is the perspective view of a battery package in accordance with an embodiment of the invention; and

FIG. 10b is a cross-sectional view of the battery package in FIG. 10a.

### DETAILED DESCRIPTION

Methods and apparatus for charging rechargeable battery array are disclosed hereinafter. In the following description, numerous specific details, including battery array size, charging voltages, currents, and the like are set forth. However, from this disclosure, it will be apparent to those skilled in the art that modifications and/or substitutions may be made without departing from the scope and spirit of the invention. In other circumstances, specific details may be omitted so as not to obscure the invention.

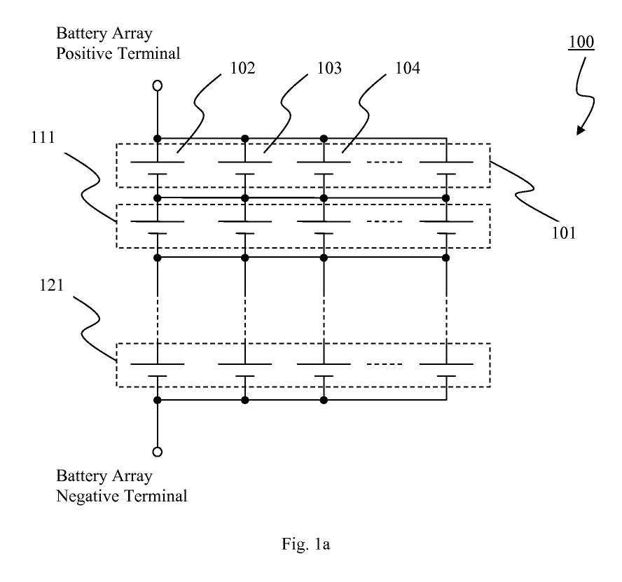

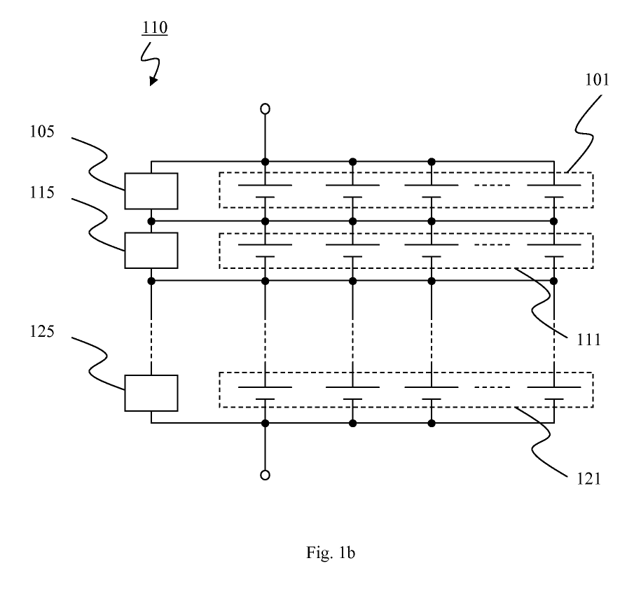

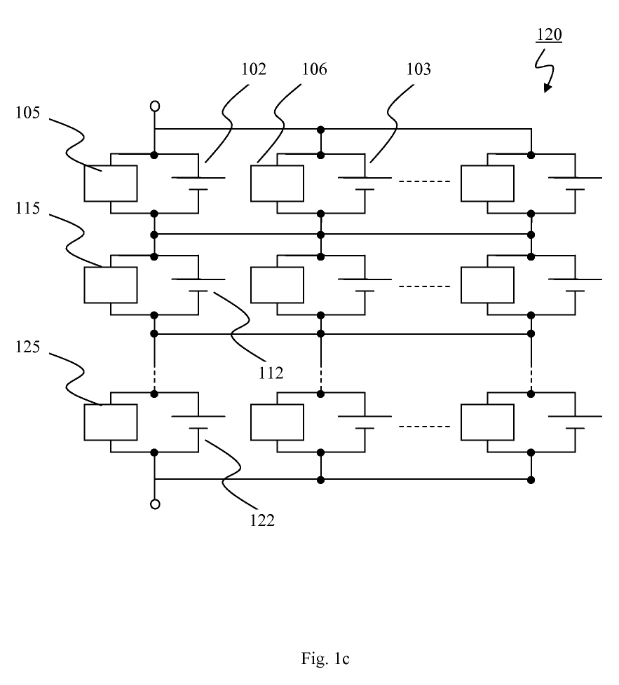

FIG. 1a illustrates a battery array 100 in conventional art composing of battery rows 101, 111, 121, etc. connected in series to provide a desired battery voltage. Each battery row comprises of battery cells 102, 103, 104, etc. connected in parallel to provide a desired battery current. Due to manufacturing process variation, production defects, or aging effect of batteries, characteristics such as energy storing capacity may vary from battery to battery.

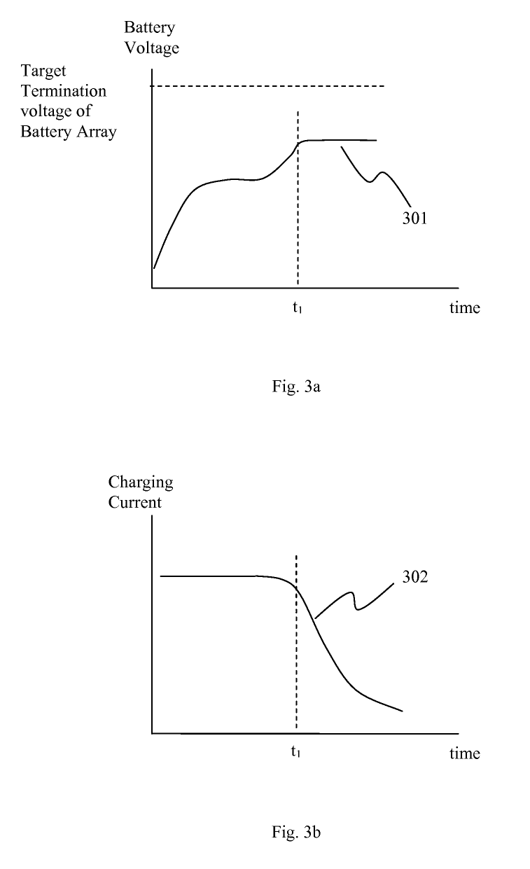

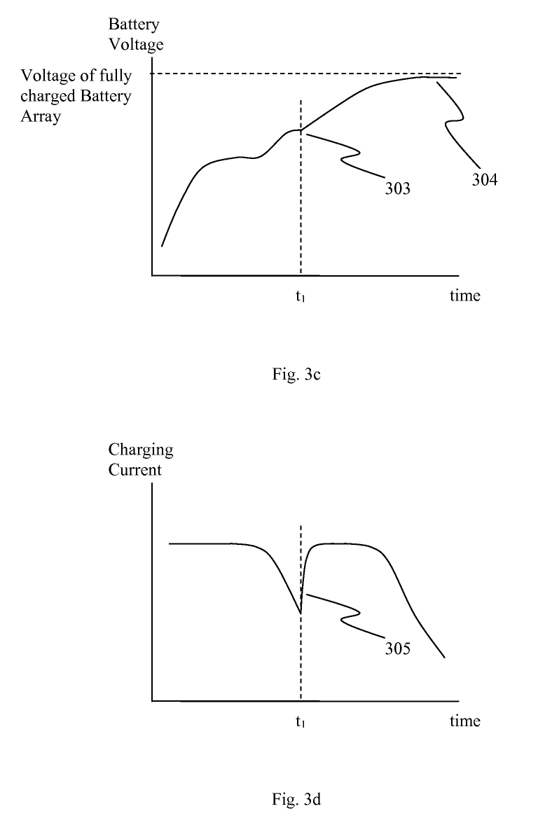

FIG. 3a is a plot of voltage across a rechargeable battery array in FIG. 1a undergoing charging process in conventional art. Because of such difference of energy storing capacity between batteries, some batteries may be fully charged earlier than the others. Referring to the battery array structures in FIG. 1, if the batteries in one of the rows get fully charged before the other rows, the charging current flowing through that particular row becomes limited. As the battery array is formed by battery rows connected in series, a current limitation in one of the rows means that the overall charging current flowing through the whole battery array is limited. FIG. 3b illustrates the overall charging current in this situation, a substantial drop 302 happens at t1 when one of the battery rows becomes fully charged. The corresponding charging profile in FIG. 3a indicates that the battery array may remain at a capped voltage 301 and never reach the target charge termination voltage (meaning the expected voltage delivered by a substantially charged up battery cell, usually ranges between 60% to 100% of the total battery cell capacity and depends on factors such as the battery chemistry and applications) because the drop of charging current 302 at t1. As a result, the charging capacity of the battery array cannot be fully utilized.

FIG. 1b is a block diagram illustrating a rechargeable battery array 110 in accordance with an embodiment of the invention. A balancing circuit 105, 115, 125 is arranged in each battery row 101, 111, 121. The balancing circuits initially provide high impedance during charging process and the battery array is being charged ordinarily. FIG. 3c shows the charging profile of a rechargeable battery array undergoing charging process in accordance with an embodiment of the invention. At t1 when one of the battery rows becomes substantially charged up (defined as the point when voltage across that battery row reaches the charge termination voltage, e.g.: 3.65V), the balancing circuit of that particular row senses that the voltage across that battery row is reaching the charge termination voltage and provides a path of constant voltage drop across that battery row. FIG. 3d is a plot of charging current for a rechargeable battery array undergoing charging process in accordance with an embodiment of the invention. At t1 when the balancing circuit starts to provide a bypass path of constant voltage drop, the overall charging current increases again at 305. The other battery rows that are not substantially charged up are again supplied with a sufficiently large charging current. As shown in FIG. 3c, the battery array is further charged at 303, and ultimately the target charge termination voltage 304 can be reached in a shorter time. The full energy storing capacity of the battery array can be utilized despite of capacity variation between battery cells.

FIG. 1c is a block diagram illustrating a rechargeable battery array 120 in accordance with yet another embodiment of the invention. Each battery cell 102, 103, 112, 122 is arranged in parallel configuration with a corresponding balancing circuit 105, 106, 115, 125. Each of such balancing circuit operates according to the voltage across the corresponding battery cell. When one of the battery rows becomes substantially charged up, the balancing circuits in that battery row detect that the voltage across the corresponding cell (which is also the voltage across that battery row) is approaching the charge termination voltage and each provides a bypass path of constant voltage drop across that particular battery cell. The architecture in FIG. 1c provides an additional advantage over FIG. 1b in which the bypass charging current flowing through the battery row is distributed among every balancing circuit in that row. This can achieve lower current in each balancing circuit and prevent overheating thereof.

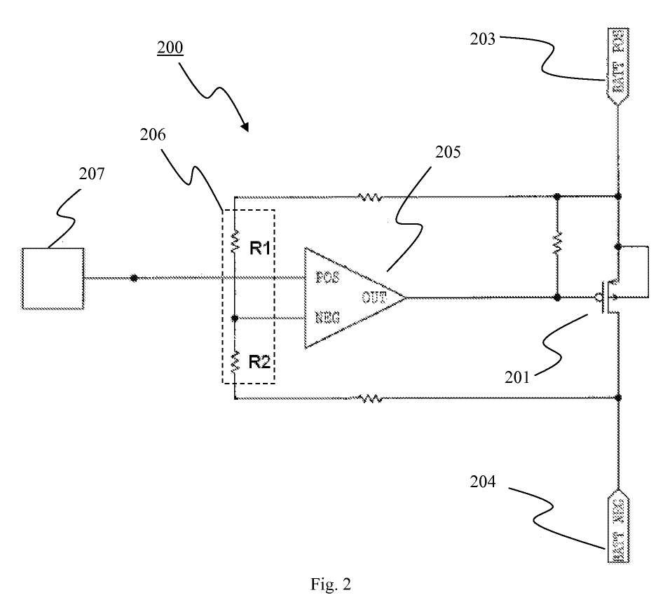

FIG. 2 is circuit schematics of a balancing circuit 200 in accordance with an embodiment of the invention. The circuit is connected in parallel with each battery row in FIG. 1b or each battery cell in FIG. 1c at two terminals: BATT POS 203 and BATT NEG 204. An active device such as Field Effect Transistor or Bipolar Junction Transistor is arranged between the two terminals to provide bypass path for charging current and is controlled by the output of a comparator 205 in an error feedback control manner. In an example of the embodiment, a p-channel Metal Oxide Field Effect Transistor (PMOS) 201 is chosen to be the active device. The comparator 205 compares a voltage divided by voltage divider 206 between BATT POS 203 and BATT NEG 204 with a reference voltage, V_{bg} generated by a bandgap reference circuit 207, which in effect amplifies the error between the battery cell voltage and the charge termination voltage. The voltage divider 206 is designed such that:

Predetermined charge termination voltage=V_{bg}×(R1+R2)/R2 (1)

Initially when the charging process of the battery cell begins, the voltage across the battery cell starts from a low voltage and the divider output voltage is much lower than bandgap reference voltage. The comparator 205 amplifies the difference between the output of voltage divider and the bandgap reference voltage and therefore outputs a high voltage level. V_{SG} of PMOS 201 is lower than threshold voltage V_{TP}, PMOS 201 is turned off and a high impedance path between the drain terminal and source terminal is provided.

As the battery cell is being charged, voltage across the battery cell rises close to the predetermined charge termination voltage in equation (1). In the meantime, the output of the voltage divider 206 also approaches the bandgap reference voltage, V_{bg}. When the battery cell is substantially charged, the output of comparator 205 gets sufficiently low such that V_{SG} of PMOS 201 is larger than threshold voltage V_{TP}, current i_{D} starts flowing through PMOS 201 and PMOS 201 itself becomes an active load. As V_{SG} further increases, the channel conductance of PMOS 201 increases as long as the transistor remains in the non-saturation region. According to the current-voltage characteristics of PMOS transistor, the impedance across the drain and source terminals of PMOS 201 decreases. Such decrease in impedance of PMOS 201 leads to a close loop feedback effect to limit further increase of the voltage across the battery cell. The voltage across the battery cell will eventually be clamped at the predetermined charge termination voltage in equation (1). In addition, a status flag signal that indicates the enabling of the bypass path can be generated, for example, by sensing the output voltage of the comparator 205. The status flag signal can further be used to drive a transducer, such as LED, to provide visual indication of the operation status of the bypass path.

The voltage divider 206 and the bandgap reference circuit 207 can be designed according to equation (1) to adjust the voltage at which the transistor 201 starts to turn on. Such flexibility allows the balancing circuit 200 to be adapted to various kinds of batteries with different charge termination voltages.

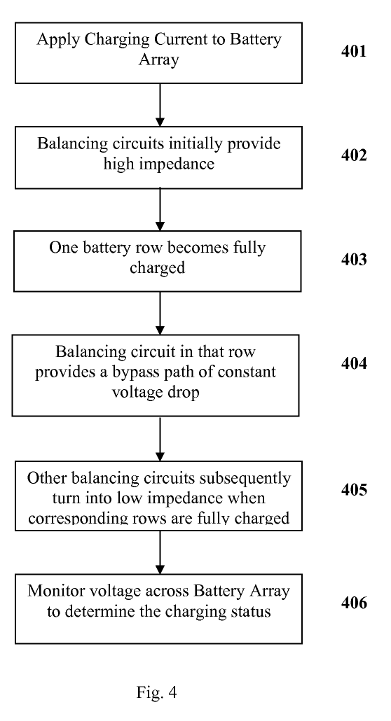

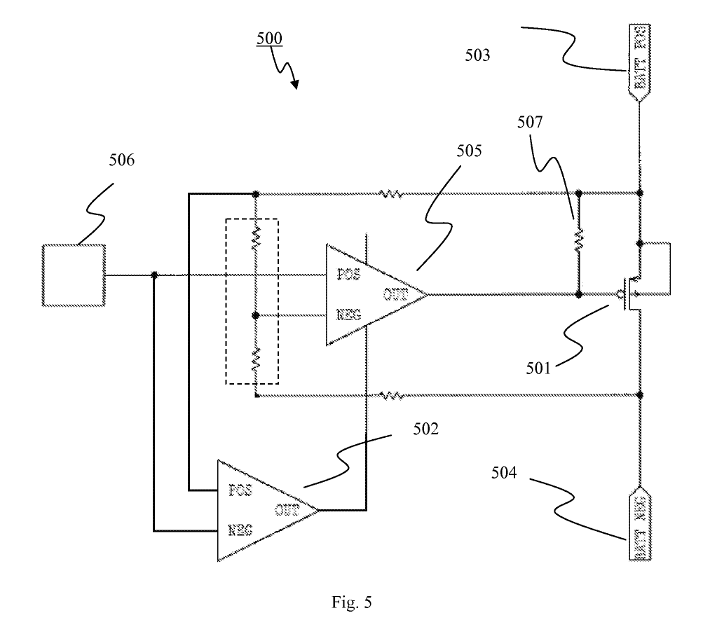

FIG. 4 is a flow diagram for the charging of a rechargeable battery array in accordance with an embodiment of the invention. Processing commences in step 401, where the charging current is applied to the battery array. The charging current may be constant or varying depending on the charging methodology.

In step 402, each balancing circuit initially provides much higher impedance than a battery cell such that the charging current mainly flows through the cell. As charging proceeds, the voltage across each battery row increases.

In step 403, one of the battery rows becomes substantially charged up earlier than the others because of manufacturing process variation, production defects, or aging effect of batteries. The corresponding balancing circuit(s) across such substantially charged up battery row senses that the batter row voltage is rising close to charge termination voltage and in step 404 provides a path of constant voltage drop as a bypass path for the charging current. Accordingly, other battery rows can still be charged efficiently.

In step 405, other battery rows subsequently become substantially charged and the corresponding balancing circuits also turn into paths of constant voltage drop. In step 406, a state of charge measuring circuit detects by comparator that the voltage across the whole battery array eventually reaches a value equaling to charge termination voltage multiplying the number of battery rows. This indicates the whole battery array is substantially charged up, the charging current is cut off and the charging process ends.

FIG. 5 is a balancing circuit 500 in accordance with a further embodiment of the invention. When the battery array with balancing circuit in FIG. 3 is used to deliver electrical energy after fully charged, the initial voltage across each balancing circuit is close to the charge termination voltage. A portion of the electrical current is undesirably consumed by the analog circuit in the balancing circuit. To achieve better power management, such current consumption has to be reduced. An Under-Voltage-Lock-Out (UVLO) circuit formed by a comparator 502 for comparing the voltage across the battery with the bandgap reference 506 is used to disable the major current consuming circuits such as comparator 505 and voltage divider. Whereas bandgap reference 506 and comparator 502 remain in operation, the overall power consumption of the balancing circuit is small as bandgap reference 506 and comparator 502 (which consumes less current than comparator 505 because of the relaxed precision requirement) only draw a very small current.

The UVLO circuit monitors the voltage across the battery terminals: BATT POS 503 and BATT NEG 504. When voltage across the terminals 503, 504 drops below a reference voltage derived from the bandgap reference circuit 506, the UVLO circuit disables the comparator 505, the voltage divider and other major current consuming circuits. The pull up resistor 507 then pulls up the gate voltage and V_{SG} drops to zero. As a result, the transistor 501 across the battery terminals 503, 504 remains as switched off.

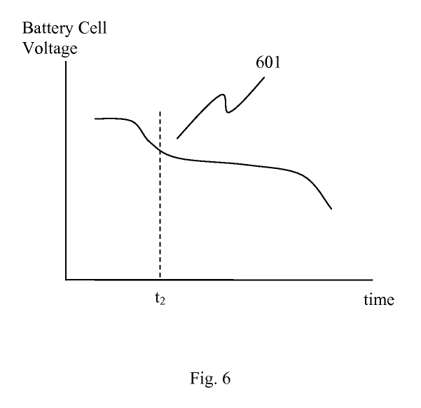

FIG. 6 is a plot of voltage across a rechargeable battery cell with balancing circuit in FIG. 5 undergoing discharging process. Initially, the transistor in the balancing circuit is turned on and provides a path of constant voltage drop across the corresponding battery cell. At t2 when the battery cell voltage drops below the threshold voltage 601 of the UVLO circuit, the UVLO circuit disables the comparator, the voltage divider and other major current consuming circuits. This reduces the major power consumption in the balancing circuit.

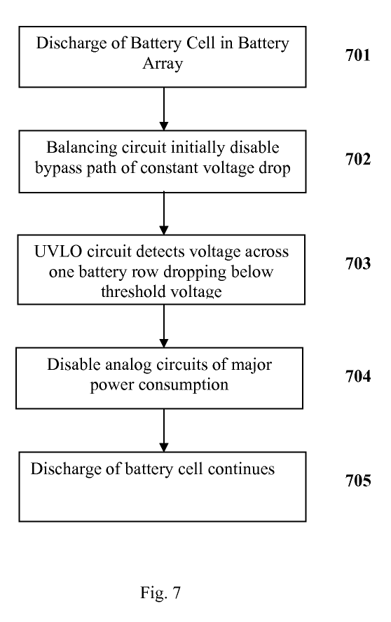

FIG. 7 is a flow diagram for the discharging of a rechargeable battery array in accordance with an embodiment of the invention. Process commences in step 701, where the battery cells in a battery array starts to discharge. Current is delivered to the load from the battery array and the voltage across each battery cell starts to drop. In step 702, as the voltage across each battery cell starts to drop, the corresponding balancing circuits disable bypass paths of constant voltage drop across battery cells. In step 703, UVLO circuit in the balancing circuit detects voltage across the corresponding battery row dropping below threshold voltage. In step 704, the UVLO disable the comparator, the voltage divider and other parts in the balancing circuits of corresponding battery row that contributes to the major current consumption. In step 705, discharge of battery cell continues and the power consumption in the balancing circuit becomes minimal.

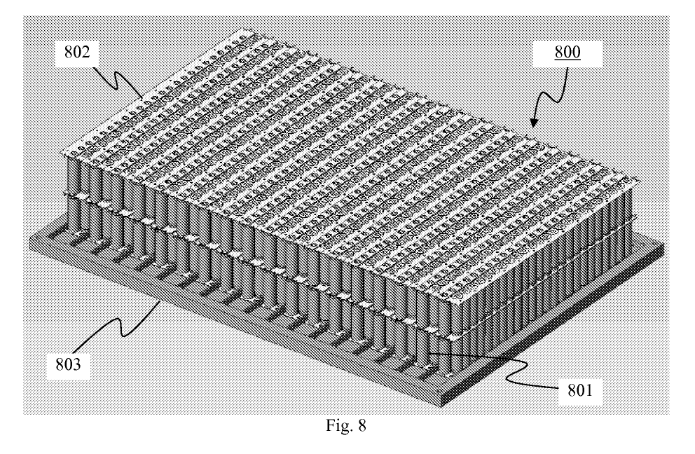

FIG. 8 shows a battery array 800 in accordance with an embodiment of the invention. A battery layer 801 is formed by 24×36 battery cells 801 packing together with all the cell anodes connected to a power bar 802. The battery layers 801 are stacked over each other in such a way that the cell cathodes of one layer are in electrical contact with the power bar of the next lower layer. All battery cells within a battery layer are therefore connected in parallel configuration, whereas the battery layers are connected in series configuration to form the battery array. The whole battery array is secured to an insulating base 803 for storage.

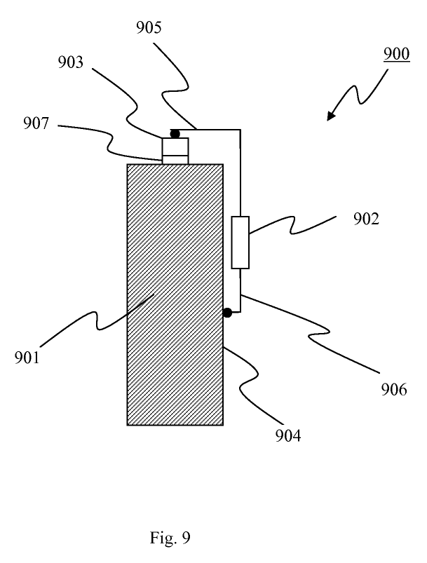

The balancing circuit can be integrated with the battery package to reduce the physical dimension of the battery array. As such, for a given physical dimension, more battery cells can be packed into the battery array to provide higher electrical energy storage capacity. FIG. 9 is the schematics of battery package 900 in accordance with an embodiment of the invention. When the balancing circuit 902 operates in bypass mode, the bypass current flowing through the active device may generate a large amount of heat. It becomes critical to dissipate such heat and prevent the circuit from overheating as well as operating at high temperature. Usually a heat sink is put on top of the circuit but the manufacturing cost and product size is increased because of the additional component. According to an embodiment of the invention, the balancing circuit 902 in the form of integrated circuit is attached to the corresponding battery cell body 901. Further to storage of chemicals and mechanical protection, the metallic battery cell housing 904 now also provides a thermal dissipation path for the balancing circuit 902. The BATT POS and BATT NEG terminals are respectively coupled to the cathode 903 and anode 904 of the battery cell through electrical connections 905, 906 such as copper wires or strips. As an example of the embodiment, the strips can be connected to the battery electrodes by arc-welding. An insulating ring 907 is disposed between the cathode 903 and anode 904 to isolate the two electrodes.

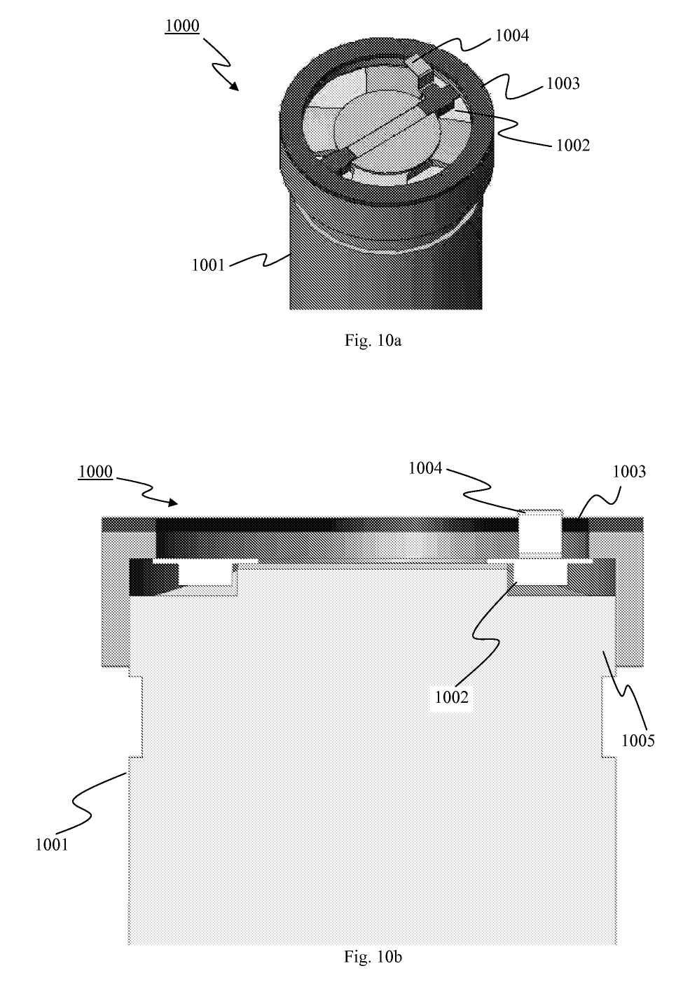

FIG. 10a is the perspective view of battery package 1000 in which the balancing circuit is integrated with the battery package in accordance with a further embodiment of the invention. The balancing circuit 1002 in integrated circuit form is bonded to a cap member 1003. The central region and rim region of the cap are electrically isolated and are connected to BATT POS and BATT NEG of the balancing circuit respectively.

The cap member 1003 is then put on the top of the battery 1001. The central region of the cap is arc-welded to the battery cathode, whereas the rim portion of the cap member is arc-welded to the lateral surface of the battery 1001 which is part of the battery anode. The cap member 1003 further comprises a metal strip 1004 for connecting the BATT POS to the power bar (not shown).

FIG. 10b is a cross-sectional view of the battery package 1000 in FIG. 10a. The balancing circuit 1002 in the form of integrated circuit is bonded to the cap member 1003. The balancing circuit 1002 has its BATT POS terminal coupled to the central region of the cap member 1003, and the central region is arc-welded to the cathode of battery cell 1001.

Similarly the BATT NEG terminal of the balancing circuit 1002 is coupled to the rim region 1005 of the cap member 1003. The rim region 1005 is subsequently coupled to the lateral surface of the battery cell, as part of the anode, by arc-welding. In addition, the metal strip 1004 connects the BATT POS terminal of the balancing circuit 1002 to the power bar.

The balancing circuit may still get overheated despite of the dissipation path described above. According to another embodiment of the invention, the balancing circuit may further comprise a thermo-protecting circuit that disables the operation of the balancing circuit when the temperature exceeds a safety margin (e.g.: over 70° C.) and thereby stops any bypassing current from flowing through the balancing circuit. When the balancing circuit subsequently cools down to a temperature safety margin (e.g.: below 50° C.), the thermo-protecting circuit detects such temperature drop and enables the balancing circuit to operate normally.

The foregoing description of embodiments of the present invention are not exhaustive and any update or modifications to them are obvious to those skilled in the art, and therefore reference is made to the appending claims for determining the scope of the present invention.

What is claimed is:

1. A rechargeable battery array, comprising:
a number of battery rows connected in series; each said battery row includes a number of battery cells connected in parallel; and
at least one balancing circuit in parallel with each said battery row and being responsive to the charging status of the corresponding battery row, wherein said balancing circuit provides a bypass path of desired constant voltage drop when the corresponding battery row is substantially charged up.

2. The rechargeable battery array of claim 1, wherein said balancing circuit provides a high impedance path in parallel with said battery row initially when charging process begins, and provides a bypass path of desired constant voltage drop in parallel with said battery row when voltage across said battery row rises close to the charge termination voltage.

3. The rechargeable battery array of claim 2, wherein said balancing circuit comprises an active device providing impedance in response to the error between a desired constant voltage drop and the actual voltage across the corresponding battery row.

4. The rechargeable battery array of claim 2, wherein said balancing circuit comprises:
a bandgap reference;
a voltage divider for dividing voltage across the corresponding battery row;
a comparator for amplifying the difference between the output of said bandgap reference and divided voltage from said voltage divider; and
an active device for providing a path across the corresponding battery row;
wherein said active device is controlled by the output of said comparator and provides an impedance in response to the output of said comparator such that the voltage drop across said path is kept constant.

5. The rechargeable battery array of claim 1, further comprising at least one balancing circuit for each said battery cell being responsive to the charging status of the corresponding battery cell, wherein said balancing circuit provides a bypass path of desired constant voltage drop when the corresponding battery cell is substantially charged up.

6. The rechargeable battery array of claim 1, wherein said balancing circuit is integrated with the package of said battery cell.

7. The rechargeable battery array of claim 6, wherein said balancing circuit is in thermal contact with battery package and makes use of the battery package for thermal dissipation.

8. The rechargeable battery array of claim 1, wherein said battery cells in the same battery row are placed in juxtaposition to form a battery layer; the anodes of all battery cells in said battery layer are connected to a power bar;
wherein said battery layers are stacked over each other such that the cathodes of all battery cells in one layer are in electrical contact with the power bar of the next lower layer; and
wherein the lowest battery layer is disposed on an insulating base.

9. The rechargeable battery array of claim 1, further comprising a state of charge measuring circuit for determining the status when said battery array gets substantially charged.

10. The rechargeable battery array of claim 9, wherein said state of charge measuring circuit comprises a voltage comparator for comparing the total voltage across said battery array with the product of the number of battery rows and the charge termination voltage.

11. The rechargeable battery array of claim 1, wherein said balancing circuit further provides a status flag indicating a bypass path of constant voltage drop is being provided.

12. The rechargeable battery array of claim 11, wherein said balancing circuit further provides visual indication in response to the value of said status flag.

13. The rechargeable battery array of claim 1, further comprising an under voltage detection circuit that disables said balancing circuit when the voltage across each battery row or battery cell gets lower than the operating voltage thereof.

14. The rechargeable battery array of claim 1, further comprising a thermo-protecting circuit that breaks the path of constant voltage drop provided by said balancing circuit at temperature beyond a safety margin.

15. The rechargeable battery array of claim 3, wherein said active device is selected from the group consisting of Field-Effect Transistor and Bipolar Junction Transistor.

16. A method for charging serially connected battery cells, comprising the steps of:
applying charging current to said serially connected battery cells;
monitoring the charge status of each battery cell;
providing a path of desired constant voltage drop across any battery cell that becomes substantially charged.

17. The method for charging serially connected battery cells according to claim 16, wherein said step of monitoring the charge status of each battery cell is carried out by comparing the voltage across the corresponding battery cell with the desired constant voltage drop.

18. The method for charging serially connected battery cells according to claim 16, wherein said step of providing a path of desired constant voltage drop further comprises the steps of:
detecting the error between said desired constant voltage drop and the actual voltage across the corresponding battery cell; and
controlling the impedance of an active device across said battery cell based on said error.

19. The method for charging serially connected battery cells according to claim 16, further comprising the step of stopping the charging current to said serially connected battery cells when all battery cells are substantially charged.

20. The method for charging serially connected battery cells according to claim 19, wherein all battery cells are determined to be substantially charged when the voltage across each battery cell reaches the charge termination voltage.

21. The method for charging serially connected battery cells according to claim 19, wherein all battery cells are determined to be substantially charged when the voltage across the serially connected battery cells reaches with the product of the number of battery cells and the charge termination voltage.

22. The method for charging serially connected battery cells according to claim 16, further comprising the step of removing said path of desired constant voltage drop when the thermal dissipation at said path exceeds a safety margin.

23. A method for discharging the rechargeable battery array of claim 17, comprising the step of disabling said path of desired constant voltage drop when the voltage across the corresponding battery cell gets lower than the operating voltage thereof.
